(19) United States
(12) Patent Application Publication
(10) Pub. No.: US 2014/0344686 A1
(43) Pub. Date: Nov. 20, 2014

(54) MEDIA CONTENT CONSUMPTION

(71) Applicant: Nokia Corporation, Espoo (FI)

(72) Inventors: Arto Juhani Lehtiniemi, Lempaala (FI); Jussi Leppanen, Tampere (FI); Antti Johannes Eronen, Tampere (FI)

(21) Appl. No.: 13/896,007

(22) Filed: May 16, 2013

(51) Int. Cl. G06F 3/0484

(52) U.S. Cl. CPC G06F 3/0484
USPC 715/716

(57) ABSTRACT

A method, apparatus and computer program instructions are provided. The apparatus comprises: at least one processor; and at least one memory storing computer program instructions configured, working with the at least one processor, to cause at least the following to be performed: causing display of a graphical item pictorially identifying media content and having an appearance that depends upon prior playback of the media content.

### TECHNOLOGICAL FIELD

Embodiments of the present invention relate to media content consumption. In particular, they relate to media content consumption at a portable electronic device.

### BACKGROUND

Users of portable electronic devices may consume various different types of media content (such as images, e-books, videos and audio) in a variety of different ways. In some cases, media content is stored locally at a device. In other cases, media content is streamed from a remote server as it is consumed.

### BRIEF SUMMARY

According to various, but not necessarily all, embodiments of the invention there is provided apparatus, comprising: at least one processor; and at least one memory storing computer program instructions configured, working with the at least one processor, to cause at least the following to be performed: causing display of a graphical item pictorially identifying media content and having an appearance that depends upon prior playback of the media content.

According to various, but not necessarily all, embodiments of the invention there is provided apparatus, comprising: means for causing display of a graphical item pictorially identifying media content and having an appearance that depends upon prior playback of the media content.

According to various, but not necessarily all, embodiments of the invention there is provided a method, comprising: causing display of a graphical item pictorially identifying media content and having an appearance that depends upon prior playback of the media content.

According to various, but not necessarily all, embodiments of the invention there is provided a non-transitory computer readable medium storing computer program instructions that, working with at least one processor, cause at least the following to be performed: causing display of a graphical item pictorially identifying media content and having an appearance that depends upon prior playback of the media content.

According to various, but not necessarily all, embodiments of the invention there is provided apparatus, comprising: at least one processor; and at least one memory storing computer program instructions configured, working with the at least one processor, to cause at least the following to be performed: determining that one or more portions of media content were skipped during playback of the media content on a first occasion; and adjusting playback of the media content on a second occasion, subsequent to the first occasion, based on the determination.

According to various, but not necessarily all, embodiments of the invention there is provided apparatus, comprising: means for determining that one or more portions of media content were skipped during playback of the media content on a first occasion; and means for adjusting playback of the media content on a second occasion, subsequent to the first occasion, based on the determination.

According to various, but not necessarily all, embodiments of the invention there is provided a method, comprising: determining that one or more portions of media content were skipped during playback of the media content on a first occasion; and adjusting playback of the media content on a second occasion, subsequent to the first occasion, based on the determination.

According to various, but not necessarily all, embodiments of the invention there is provided a non-transitory computer readable medium storing computer program instructions that, working with at least one processor, cause at least the following to be performed: determining that one or more portions of media content were skipped during playback of the media content on a first occasion; and adjusting playback of the media content on a second occasion, subsequent to the first occasion, based on the determination.

According to various, but not necessarily all, embodiments of the invention there is provided a method, comprising: providing credit that enables a user to skip playback of media content items; identifying that a user has provided input to skip from playing a first media content item to playing a second media content item; and determining, on the basis of at least one contextual characteristic associated with the input, a value by which to reduce the credit.

According to various, but not necessarily all, embodiments of the invention there is provided a non-transitory computer readable medium storing computer program instructions that, working with at least one processor, cause at least the following to be performed: providing credit that enables a user to skip playback of media content items; identifying that a user has provided input to skip from playing a first media content item to playing a second media content item; and determining, on the basis of at least one contextual characteristic associated with the input, a value by which to reduce the credit.

According to various, but not necessarily all, embodiments of the invention there is provided apparatus, comprising: at least one memory storing computer program instructions configured, working with the at least one processor, to cause at least the following to be performed: providing credit that enables a user to skip playback of media content items; identifying that a user has provided input to skip from playing a first media content item to playing a second media content item; and determining, on the basis of at least one contextual characteristic associated with the input, a value by which to reduce the credit.

According to various, but not necessarily all, embodiments of the invention there is provided apparatus, comprising: means for providing credit that enables a user to skip playback of media content items; means for identifying that a user has provided input to skip from playing a first media content item to playing a second media content item; and means for determining, on the basis of at least one contextual characteristic associated with the input, a value by which to reduce the credit.

According to various, but not necessarily all, embodiments of the invention there is provided a method, comprising: providing credit that enables a user to skip playback of media content items; identifying that a user has provided first input to skip from playing a first media content item to playing a second media content item; reducing the credit in response to the first input; identifying that a user has provided a second input to revert back and play at least a skipped portion of the first media content item; and increasing the credit because the user has reverted back and played at least the skipped portion of the first media content item.

According to various, but not necessarily all, embodiments of the invention there is provided a non-transitory computer readable medium storing computer program instructions that, working with at least one processor, cause at least the following to be performed: providing credit that enables a user to skip playback of media content items; identifying that a user has provided first input to skip from playing a first media content item to playing a second media content item; reducing the credit in response to the first input; identifying that a user has provided a second input to revert back and play at least a skipped portion of the first media content item; and increasing the credit because the user has reverted back and played at least the skipped portion of the first media content item.

According to various, but not necessarily all, embodiments of the invention there is provided apparatus, comprising: at least one memory storing computer program instructions configured, working with the at least one processor, to cause at least the following to be performed: providing credit that enables a user to skip playback of media content items; identifying that a user has provided first input to skip from playing a first media content item to playing a second media content item; reducing the credit in response to the first input; identifying that a user has provided a second input to revert back and play at least a skipped portion of the first media content item; and increasing the credit because the user has reverted back and played at least the skipped portion of the first media content item.

According to various, but not necessarily all, embodiments of the invention there is provided apparatus, comprising: means for providing credit that enables a user to skip playback of media content items; means for identifying that a user has provided first input to skip from playing a first media content item to playing a second media content item; means for reducing the credit in response to the first input; identifying that a user has provided a second input to revert back and play at least a skipped portion of the first media content item; and means for increasing the credit because the user has reverted back and played at least the skipped portion of the first media content item.

### BRIEF DESCRIPTION

For a better understanding of various examples that are useful for understanding the brief description, reference will now be made by way of example only to the accompanying drawings in which:

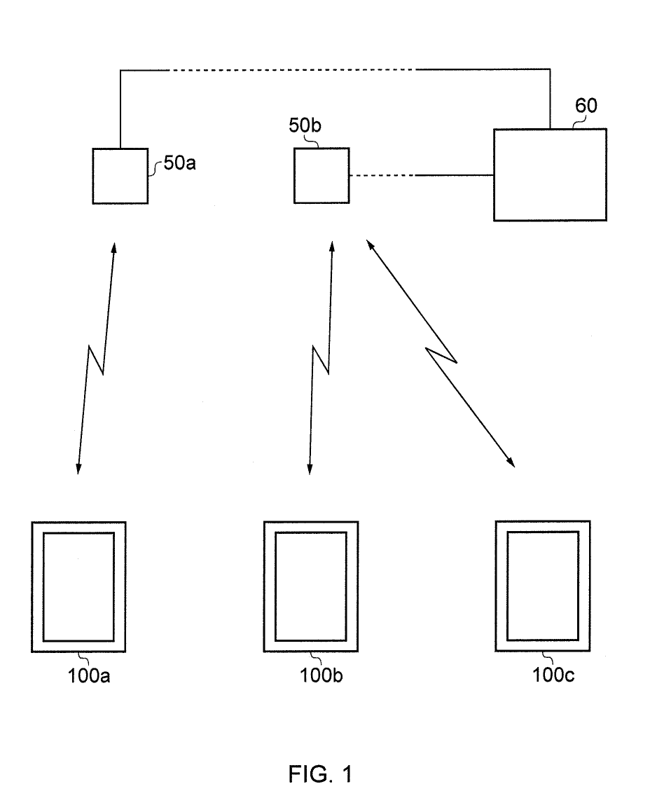

FIG. 1 illustrates a system comprising a server, a plurality of network access points and multiple electronic devices;

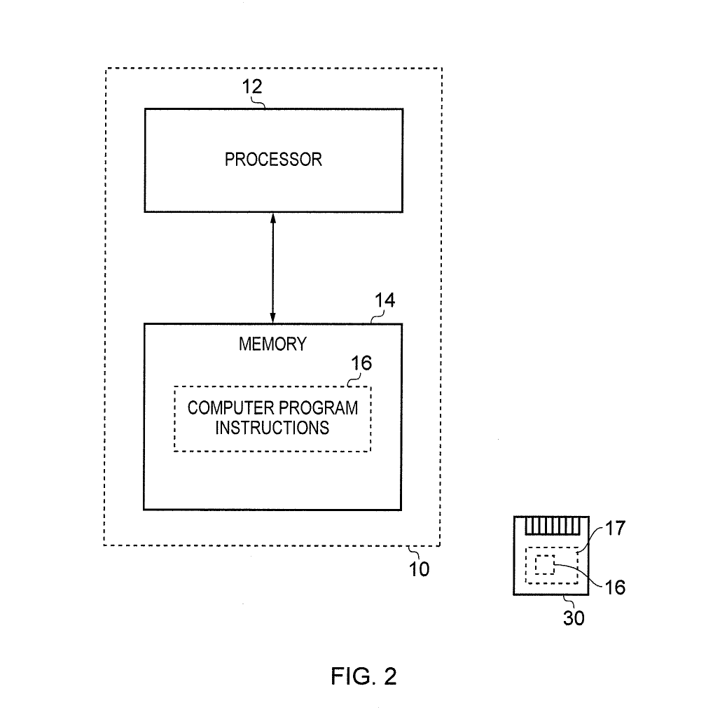

FIG. 2 illustrates a chipset of an electronic device;

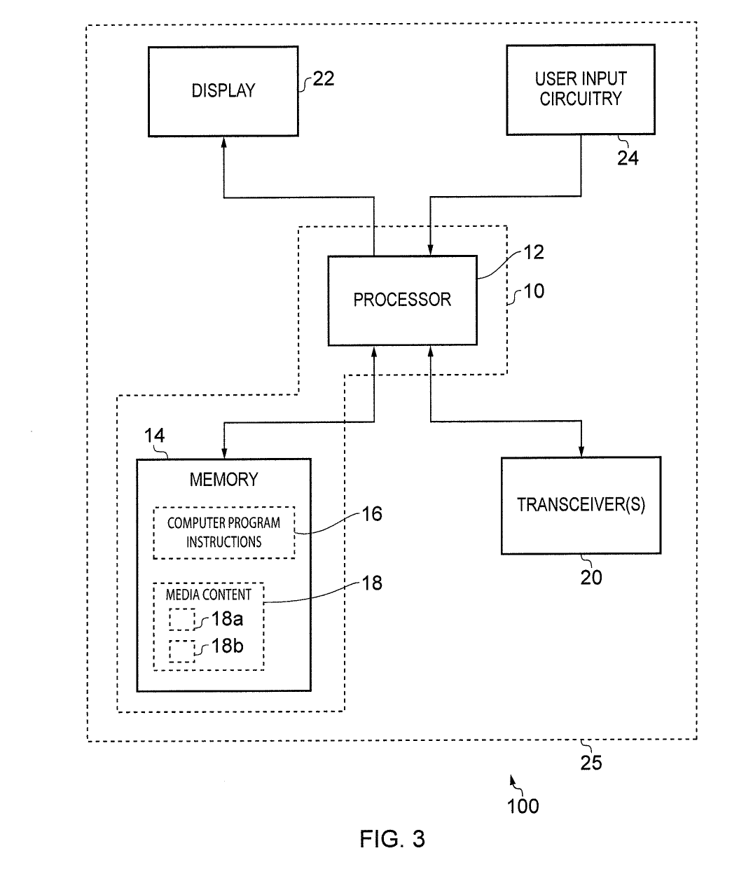

FIG. 3 illustrates a schematic of an electronic device;

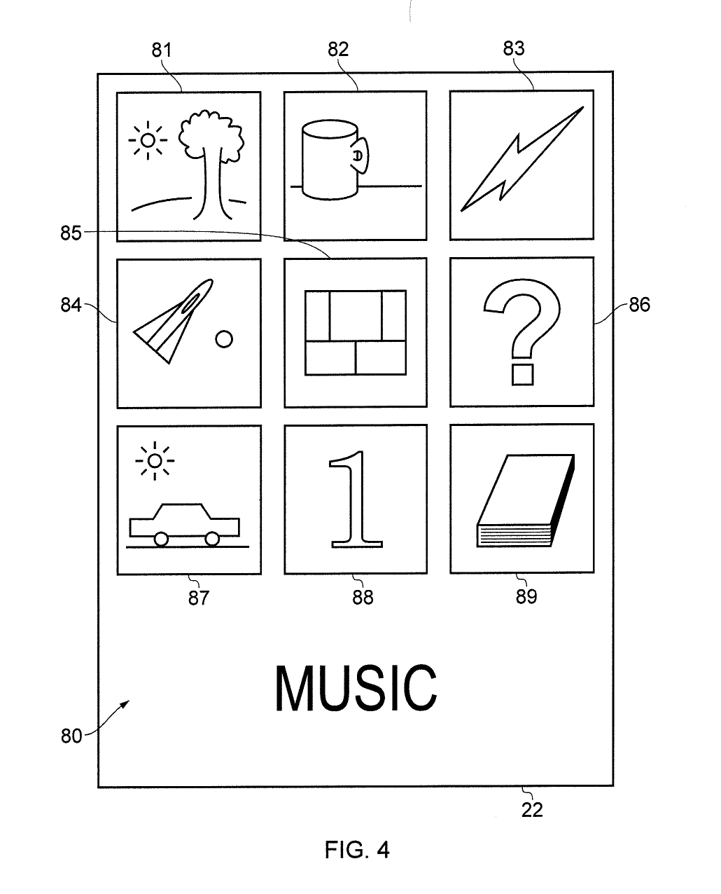

FIG. 4 illustrates an electronic device displaying a plurality of graphical items, each of which pictorially identifies media content;

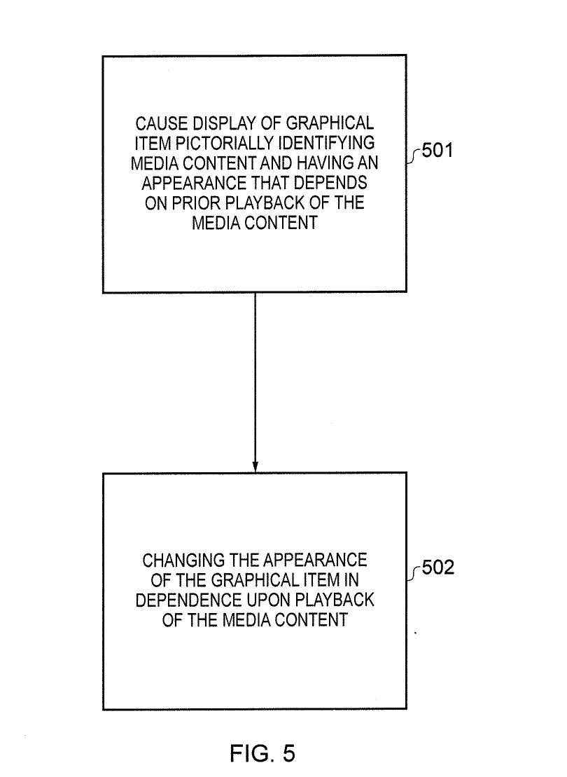

FIG. 5 illustrates a schematic of a first method;

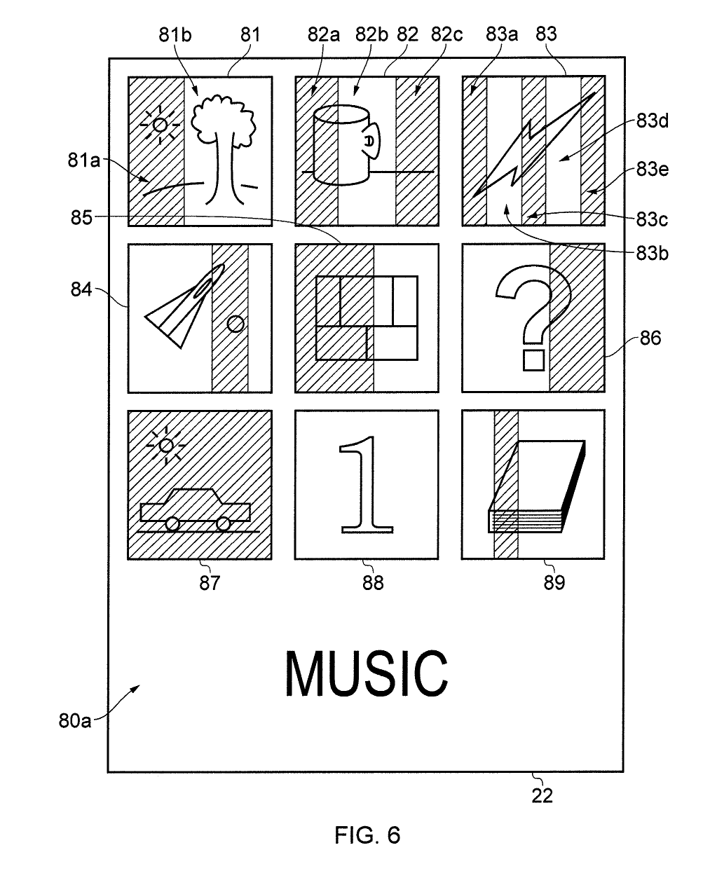

FIG. 6 illustrates an example in which the appearance of each graphical item indicates a prior playback history of media content;

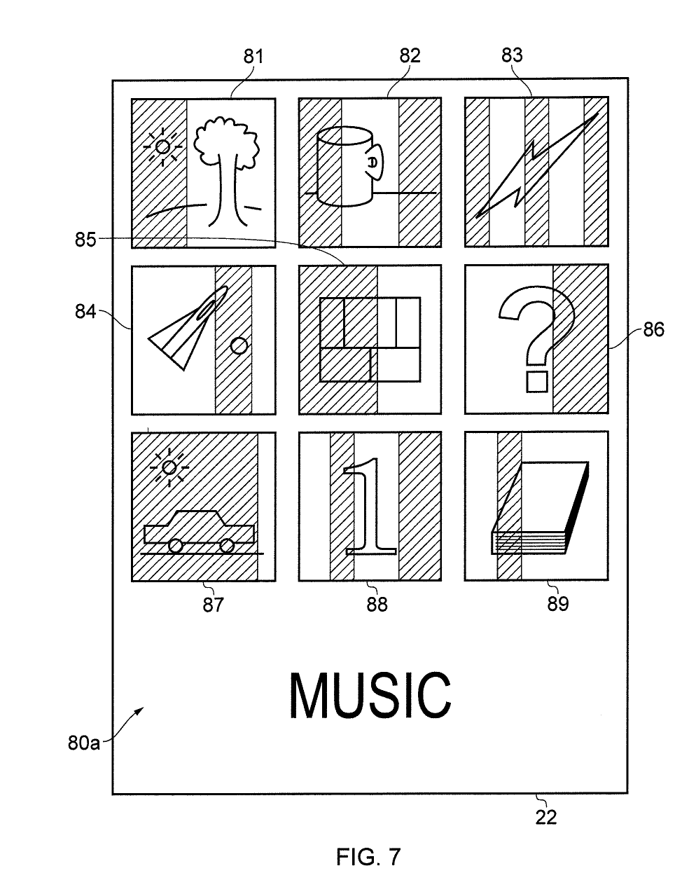

FIG. 7 illustrates an example where the appearance of some of the graphical items has changed, relative to FIG. 6, due to a change in the playback history for some of the graphical items;

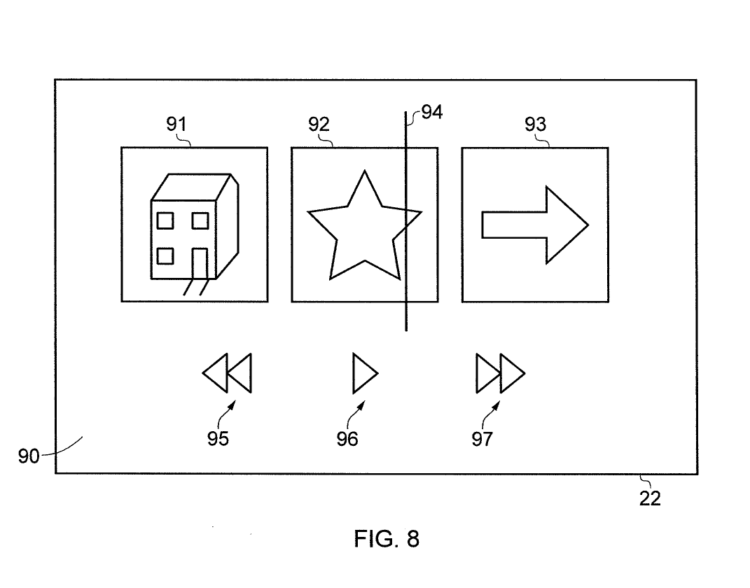

FIG. 8 illustrates a media player, displayed on an electronic device, where the appearance of each graphical item may indicate a prior playback history of media content;

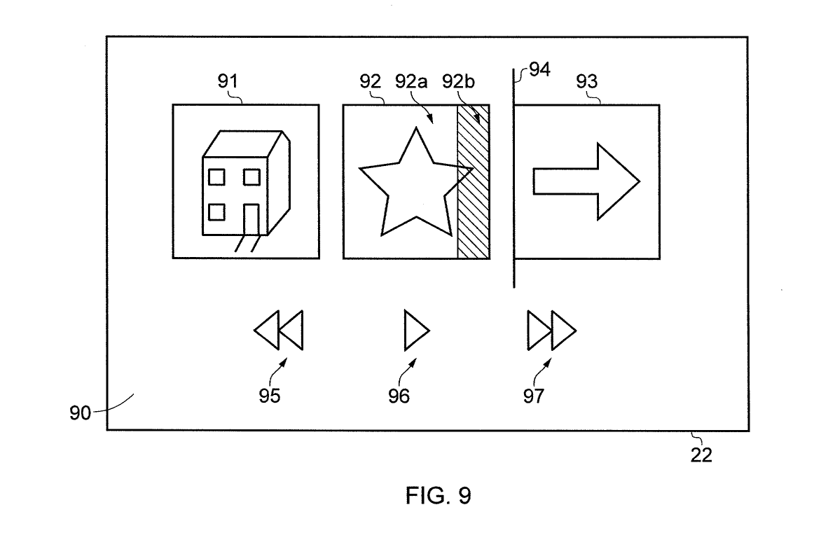

FIG. 9 illustrates the media player of FIG. 8, after playback of some media content has been skipped;

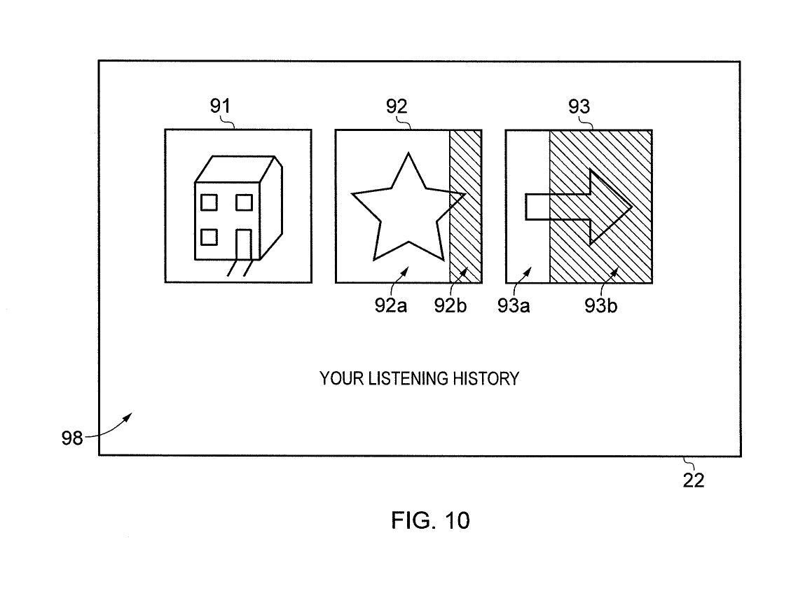

FIG. 10 illustrates a listening history screen displayed on an electronic device; and

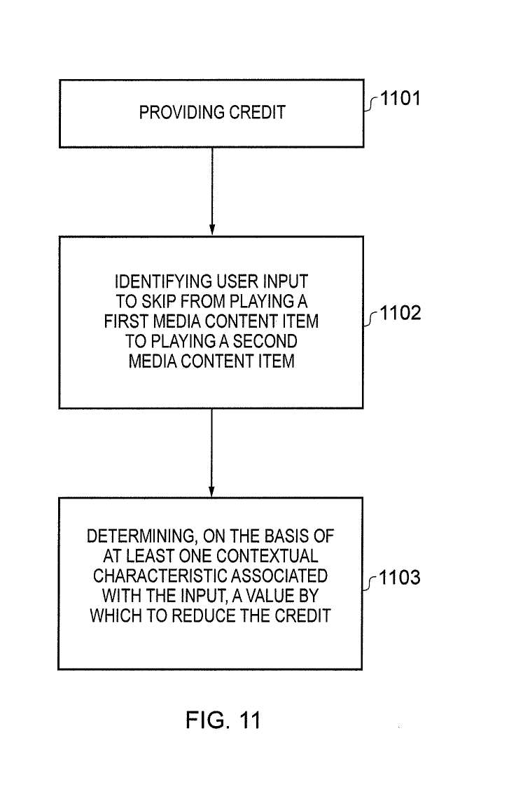

FIG. 11 illustrates a schematic of a second method.

### DETAILED DESCRIPTION

Embodiments of the invention relate to media consumption and, in particular, to consumption of audio content such as music. FIG. 1 illustrates a system comprising a server 60, a plurality of network access points 50a, 50b and a plurality of electronic devices 100a, 100b, 100c. The server 60 is at a remote location relative to the electronic devices 100a, 100b, 100c.

FIG. 1 illustrates a single server 60, two access points 50a, 50b and three electronic devices 100a, 100b, 100c for illustrative purposes but, in practice, there may be multiple servers and many more network access points and electronic devices.

The electronic devices 100a, 100b, 100c are media content playback devices. They may, for example, include mobile telephones, portable music players, game consoles, tablet computers, laptop computers, desktop computers and household appliances.

In the example illustrated in FIG. 1, a first electronic device 100a is a connected to the server 60 via a first access point 50a, and second and third electronic devices 100b, 100c are connected to the server 60 via a second network access point 50b.

The network access points 50a, 50b could, for example, include cellular access points such as cellular base stations and Wireless Local Area Network (WLAN) access points.

In this example, the electronic devices 100a, 100b, 100c are configured to stream media content from the server 60, via the network access points 50a, 50b. The media content may be audio content, such as music, and/or video content, such as movies and television shows. The media content is played back as it is streamed from the server 60. Each electronic device 100a, 100b, 100c may also be configured to store media content in a local memory.

FIG. 2 illustrates an apparatus 10 that may be a chip or a chipset. The apparatus 10 may form part of an electronic device such as those illustrated in FIG. 1.

The apparatus 10 comprises at least one processor 12 and at least one memory 14. A single processor 12 and a single memory 14 are shown in FIG. 1 for illustrative purposes.

The processor 12 is configured to read from and write to the memory 14. The processor 12 may comprise an output interface via which data and/or commands are output by the processor 12 and an input interface via which data and/or commands are input to the processor 12.

The memory 14 stores computer program instructions/code 16 that control the operation of the apparatus 10 when loaded into the processor 12. The computer program code 16 provides the logic and routines that enables the apparatus 10 to perform at least part of the methods illustrated in FIGS. 5 and 11. The processor 12, by reading the memory 14, is able to load and execute the computer program instructions 16.

Although the memory 14 is illustrated as a single component it may be implemented as one or more separate components some or all of which may be integrated/removable and/or may provide permanent/semi-permanent/dynamic/cached storage.

The computer program instructions 16 may arrive at the apparatus 10 via any suitable delivery mechanism 30. The delivery mechanism 30 may be, for example, a non-transitory computer-readable storage medium such as a compact disc read-only memory (CD-ROM) or digital versatile disc (DVD). The delivery mechanism 30 may be a signal configured to reliably transfer the computer program instructions 16. The apparatus 10 may cause the propagation or transmission of the computer program instructions 16 as a computer data signal.

FIG. 3 illustrates an example 100 of the electronic devices 100a, 100b, 100c illustrated in FIG. 1.

The electronic device/apparatus 100 illustrated in FIG. 3 includes one or transceivers 20, a display 22, user input circuitry 24, an external housing 25 and the apparatus 10 illustrated in FIG. 2. In this example the external housing 25 houses the one or more transceivers 20, the display 22, the user input circuitry 24, the processor 12 and the memory 14.

The display 22 is configured to display information under the control of the processor 12. The display 22 may be any type of display. It may, for example, be a liquid crystal display (LCD), an organic light emitting diode (OLED) display or a quantum dot display.

The user input circuitry 24 is configured to receive inputs from a user. In response to receiving an input from a user, the user input circuitry 24 provides a signal to the processor 12 that depends upon the input that has been provided by the user.

In some embodiments of the invention, at least part of the user input circuitry 24 is integrated with the display 22, in the form of a touch sensitive display. The touch sensitive display may be any type of touch sensitive display. It might function, for example, using capacitive, resistive, infrared, dispersive signal and/or acoustic pulse technology.

The transceiver(s) 20 may be configured to transmit and receive radio frequency signals. The transceiver(s) 20 might be compatible with one or more radio protocols, such as cellular or IEEE (Institute of Electrical and Electronic Engineers) protocols.

The memory 14 is illustrated in FIG. 3 as storing media content 18 in the form of data. The stored media content 18 includes a plurality of media content items 18a, 18b. The media content 18 might be audio content such as music, in which case each media content item 18a, 18b could be an individual audio track. Alternatively, the media content 18 might be video content, in which case each media content item 18a, 18b could be a movie or a television show.

The elements 12, 14, 20, 22 and 24 are operationally coupled and any number or combination of intervening elements can exist between them (including no intervening elements).

FIG. 4 illustrates an example in which the processor 12 of the electronic device 100 is controlling the display 22 to display a screen 80 comprising a plurality of graphical items 81-89. The graphical items 81-89 are displayed simultaneously. In this example, each graphical item 81-89 pictorially identifies media content.

Each graphical item 81-89 might identify and represent a single media content item or a plurality of media content items. In the illustrated example, the media content is audio content in the form of music. Each graphical item 81-89 might, therefore, represent a single audio track or a collection of audio tracks (such as an album or a playlist).

In FIG. 4, each graphical item 81-89 is an image in the form of artwork. The artwork pictorially identifies the media content. In circumstances where each graphical item 81-89 represents an album, the artwork might be that which would appear on the sleeve of a hard copy version of the album (such as a compact disc version).

Some or all of the media content identified by the graphical items 81-89 might be stored locally in the memory 14. Alternatively or additionally, some or all of the media content identified by the graphical items 81-89 might not be stored locally and might instead be content that is streamable from a streaming service (such as a music streaming service). Such a streaming service might be provided by the server 60 illustrated in FIG. 1.

As mentioned above, in some implementations of the invention, the media content that is represented by the graphical items 81-89 might not be audio content. It might, for example, be video content. If so, each graphical item 81-89 could represent a movie, a collection of movies, an episode of a television show or a season of episodes of a television show.

The processor 12 is configured to control the display 22 to display a screen 80a, similar to that illustrated in FIG. 4, which additionally conveys a prior playback history to a user via the graphical items 81-89. This is shown in FIG. 6. The display of such a screen 80a may enable a user to see his playback history quickly and straightforwardly.

An example of how the screen 80a is displayed is described below with reference to FIGS. 5 and 6.

The processor 12 is configured to divide each graphical item 81-89 into a plurality of portions, where each portion relates to a particular media content portion that is represented by the graphical item. A media content portion may be a discrete media content item, such as an audio track.

If, for example, a particular graphical item represents ten media content portions (for instance, a ten track album), the processor 12 divides the graphical item into ten different portions, where each portion is associated with an individual media content portion. The processor 12 may, for instance, divide each graphical item 81-89 into vertical slices, where each vertical slice is associated with an individual media content portion.

The processor 12 is also configured to store a tally/count (in the memory 14, for example) of the number of times a particular media content portion has been played by a user. This might be the number of times the media content portion has been played by the electronic device 100, or the number of times the particular media content portion has been played by the user across a number of electronic devices owned by him.

When a user provides user input at the user input circuitry 24 that is intended to cause the electronic device 100 to display the screen 80a illustrated in FIG. 6, at block 501 in FIG. 5, the processor 12 of the electronic device 100 causes the display 22 to display the screen 80a comprising the graphical items 81-89, such that each graphical item 81-89 pictorially identifies media content and has an appearance that depends upon prior playback of that media content. Portions of a particular graphical item that represent more frequently played portions of media content are displayed differently from other portions of that graphical item that represent less frequently played portions of the media content.

For example, in this regard, each graphical item may include one or more highlighted portions and one or more shaded portions. In this example, the highlighted portions are full colour portions of artwork. They are considered to be “highlighted” due to their prominent appearance relative to the shaded portions. The shaded portions might, for example, be portions where the artwork is displayed in grayscale.

The highlighting of some portions of a graphical item relative to others graphically identifies which portions of media content are more frequently played than others.

In implementations where the media content portions are discrete media content items such as audio tracks, media content items/tracks that are represented by a particular graphical item may have a predefined order. For example, audio tracks in an album or playlist may be numbered. The processor 12 may be configured to allocate different portions of a graphical item to different media content items based on the predefined order.

In the example of the screen 80a illustrated in FIG. 6, each graphical item 81-89 is divided into portions by processor 12, where the leftmost portion is allocated to the earliest media content item/track in the predefined order and the rightmost portion is allocated to the latest track in the predefined order.

In this particular example, each media content portion/track is allocated the same area of a graphical item irrespective of its length. The total highlighted area in a graphical item is therefore directly proportional to the number of “more frequently played” tracks that are represented by the graphical item. In other examples, the area of a graphical item that is allocated to particular media content item/track may depend upon its length. In these examples, the total highlighted area in a graphical item is directly proportional to the amount of time in the media content/album/playlist represented by the graphical item that is considered to be “more frequently played”.

The first graphical item 81 illustrated in FIG. 6 represents a first album consisting of twelve tracks having a predefined order. The leftmost portion 81a of the graphical item 81, representing the first five tracks in the first album, is shaded and the rightmost portion 81b, representing the last seven tracks in the first album, is highlighted. This is because the user of the electronic device 100 has listened to the first five tracks in the album less frequently than the last seven tracks.

The second graphical item 82 illustrated in FIG. 6 represents a second album consisting of fifteen tracks having a predefined order. The leftmost portion 82a and the rightmost portion 82c, representing the first four tracks in the second album and the last four tracks in the second album respectively, are shaded. The central portion 82b, representing the middle seven tracks in the second album, is highlighted. This is because the user has listened to the first four tracks and the last four tracks in the second album more frequently than the middle seven tracks.

The third graphical item 83 illustrated in FIG. 6 represents a third album consisting of thirteen tracks having a predefined order. Three shaded portions 83a, 83c, 83e represent track numbers one, two, six, seven, eleven and twelve and two highlighted portions 83b, 83d represent track numbers three, four, five, eight, nine and ten. This is because the user has listened to tracks three, four, five, eight, nine and ten more frequently than tracks one, two, six, seven, eleven and twelve.

In order to identify which portions/items/tracks of media content should be graphically identified to be “less frequently played” and which portions should be identified to be “more frequently played”, the processor 12 carries out a sorting process. This can be performed in many different ways.

According to one sorting process, the processor 12 determines whether a particular media content portion has been played more than a threshold number of times. If so, it is identified as a more frequently played portion. If not, is identified as a less frequently played portion.

According to another sorting process, the processor 12 determines which media content portion (of a plurality represented by a particular graphical item) has been played the most frequently. The processor 12 then identifies that portion as a more frequently played portion, along with any others that have a play count falling within a certain range of the play count of the most frequently played portion. All of the other media content portions are identified to be less frequently played portions.

In some examples, the media content portions/items that are identified to be “less frequently played” might never have been played by the user.

In the method illustrated in FIG. 5, a period of time elapses over which the user of the electronic device 100 continues to play media content using the electronic device 100. The processor 12 continues to update the tally/count of the number of times media content portions have been played by the user.

At block 502 in FIG. 5, the processor 12 causes the appearance of the screen 80a and at least some of the graphical items 81-89 to change. For example, some media content portions that were previously identified to be more frequently played portions are identified to be less frequently played portions. Alternatively or additionally, some media content portions that were previously identified to be less frequently played portions are identified to be more frequently played portions.

An example of the updated screen 80a is illustrated in FIG. 7. It can be seen that, relative to FIG. 6, the appearance of the graphical items identified by the reference numerals 87 and 88 have changed.

FIG. 8 illustrates the processor 12 controlling the display to display a media player screen 90. The media player screen 90 enables a user to cause the electronic device 100 to play media content.

The media player screen 90 includes three user selectable graphical items 95, 96, 97 that enable a user to control the playback of media content. The back graphical item 95 enables a user to skip back to a previous media content item, the fast forward graphical item 97 enables a user to skip forward to a future media content item and the playback graphical item 96 enables a user to initiate playback of media content.

The media player screen 90 also includes three graphical items 91, 92, 93 that each represent media content. In this example, each graphical item 91, 92, 93 represents a different media content portion/item in the form of a single audio track.

Each of the graphical items 91, 92, 93 is an image in the form of artwork. The artwork pictorially identifies the media content portion/item. In this example, where each graphical item 91-93 represents a single audio track, the artwork might be that which would appear on the sleeve of a hard copy version of the track (such as a compact disc version).

The screen 90 illustrated in FIG. 8 further comprises a currently playing indicator 94. FIG. 8 depicts a situation where a track represented by the central graphical item 94 is being played. The leftmost graphical item 91 represents a track that has already been played. The rightmost graphical item 93 represents a track that is in line to be played after the item/track represented by the central graphical item 92 has been played.

In this example, the user selects the fast forward graphical item 97, which causes the processor 12 to respond by skipping playback of the remaining portion of the current track (represented by the central graphical item 92). The processor 12 controls the electronic device 100 to begin playing the track represented by the rightmost graphical item 93 and moves the currently playing indicator 94 accordingly. This is illustrated in FIG. 9.

It can also be seen in FIG. 9 that the processor 12 also controls the appearance of the central graphical item 92 to graphically identify that a portion of the track represented by the central graphical item 92 was not played (and was skipped by the user). A portion 92a of the graphical item 92 is highlighted and a portion 92b is shaded. The highlighted portion 92a relates to the played portion of the track and the shaded portion 92b relate to the unplayed portion of the track. The highlighting of one portion relative to another identifies that a portion of the track was played by a user and a portion was skipped by the user.

In this example, the processor 12 of the electronic device 100 has divided the central graphical item 92 into portions, and allocated the different portions of the graphical item 92 to different portions of the content/track identified by the graphical item 92. For instance, the leftmost side of the graphical item relates to the start of the content/track and the rightmost side relates to the end of the content/track.

The proportion of the graphical item 92 that is highlighted (rather than shaded) is the same proportion of the content/track that was played (rather than skipped). The proportion of the graphical item 92 that is shaded is the same proportion of the content/track that was skipped by the user.

The highlighted portion may be a full colour portion of artwork that is considered to be “highlighted” due to its prominent appearance relative to the shaded portion. The shaded portion might, for example, be a portion where the artwork is displayed in grayscale.

The media player screen 90 illustrated in FIGS. 8 and 9 might be provided to enable a user to listen to music from a music streaming service provided, for instance, by the server 60 illustrated in FIG. 1.

In some examples, the music streaming service may allocate credit that enables users to skip tracks streamed to the electronic device 100 by the server 60. The credit may be provided to the user via a software application stored in the memory 14 of the electronic device 100. The software application may form part of the computer program instructions 16.

The user may receive a limited amount of credit in a given time period, thus meaning that only a limited number of “skips” are available to the user over that time period. For example, the credit may enable a user to skip only six tracks in any given day.

According to some implementations of the invention, the media player screen 90 may be implemented in accordance with a scheme that enables a user to “earn back” skip credit that has been previously used. In such implementations, user selection of the rewind item 95 may cause the processor 12 to control the electronic device 100 to revert back to playing at least a portion of a media content item that has been skipped previously. If the user listens to at least the previously skipped portion, he “earns back” the credit that he lost for making the skip. The processor 12 is configured to identify that the user has provided an input to revert back to playing at least the skipped portion of the media content item/track and increases the credit because the user has reverted back and played the at least the skipped portion of the media content item/track.

For example, the user may lose 1 skip credit of the 6 skip credits that he has for use in any one day when he makes a skip. If the user reverts back and listens to a previously skipped portion of a track, he earns that 1 skip credit back.

In some examples, the processor 12 only enables the user to revert back and play the portion of a media content item that was skipped. In other examples, the processor 12 only enables the user to revert back and play the whole of the media content item in respect of which a portion of skipped (and not just the skipped portion). In further examples, the processor 12 enables the user to choose whether he wishes to revert back and play the whole of the media content item, or just the portion that was skipped.

The media player screen 90 may enable a user to see which media content portions have been skipped and, in the context of the above example, which media content portions he must go back and play to earn back some used skip credit.

FIG. 10 illustrates an example of a media content playback history screen 98. In this example, since the media content is audio content, the screen 98 relates to a listening history.

The screen 98 comprises the three graphical items 91-93 that were also pictured in FIGS. 8 and 9. The whole of the first graphical item 91 is “highlighted” in the sense that it appears in full colour. This identifies that the user played the whole of the track that is identified by the first graphical item 91.

The second graphical item 92 includes a highlighted portion 92a and a shaded portion 92b. The highlighted portion 92a identifies a portion of the media content/track (represented by the second graphical item 92) that was played by the electronic device 100, and the shaded portion 92b identifies a portion of the media/track that was skipped.

The third graphical item 93 also includes a highlighted portion 93a and a shaded portion 93b. Similarly, the highlighted portion 93a identifies a portion of the media content/track (represented by the third graphical item 93) that was played by the electronic device 100, and the shaded portion 93b identifies a portion of the media/track that was skipped.

In some embodiments of the invention, the processor 12 is configured to provide a user selectable option that enables a user to cause the electronic device to play media content in a similar manner to how it has been played previously. In response to the user selection of the option, the processor 12 determines that one or more portions of the media content (for instance, in a playlist or album) were manually skipped by the user during playback of that media content on an earlier occasion. The processor 12 then controls the playback of the media content (on this subsequent occasion) based on the determination. The processor 12 may do this by adjusting playback of the media content by automatically skipping (that is, without user intervention) on the subsequent occasion the one or more portions of the media content that were manually skipped during the earlier occasion. This may involve skipping whole media content items/tracks, or skipping one or more portions of particular media content items/tracks.

FIG. 11 is a flow chart of a method which relates to controlling the skip credit for a media content streaming service, such as that described above. As mentioned above, the media content streaming service may be an audio content/music streaming service, and may be provided by the server 60 illustrated in FIG. 1.

The method may be carried out entirely or in part by a software application stored in the memory 14 of the electronic device 100. The software application may form part of the computer program instructions 16 illustrated in FIG. 1. The software application may relate to a particular media content/music streaming service and may be downloadable from an application store. Alternatively or additionally, the method may be carried out entirely or in part by a software application/computer program instructions stored in a memory of a server (such as the server 60 illustrated in FIG. 1) which is associated with a streaming service and which has some control of the electronic device 100.

At block 1101 in FIG. 11 the software application, working with the processor 12 of the electronic device 100, provides credit to a user of the electronic device 100 that enables the user to skip playback of media content items, such as audio tracks. The credit may be allocated to a particular user account, such as it can be used across multiple electronic devices. Alternatively, the credit may be allocated to a particular electronic device, such that it can only be used at that electronic device.

The user may receive a limited amount of credit in a given time period, thus meaning that only a limited number of “skips” are available to the user over that time period. For example, the credit may enable a user to skip only six tracks in any given day.

A user provides user input at the user input circuitry 24 to control the processor 12 to cause the playback of a first media content item, such as an audio track, via the streaming service. The media content item may be played, for example, using the media player illustrated in FIGS. 8 and 9.

At block 1102 in FIG. 11, the user provides input to skip from playing the first media content item/track to playing a second media content item/track. This may be done, for example, in the manner described above in relation to FIGS. 8 and 9. The processor 12, under the control of the software application, identifies that the user has provided the skip input.

At block 1103 in FIG. 11, under the control of the software application, the processor 12 determines a value by which to reduce the credit that was provided to the user. The determination is made on the basis of at least one contextual characteristic associated with the user input. That is, the context in which the skip input is made affects how the credit is reduced.

An example was described above in relation to FIGS. 8 and 9 in which the user lost 1 skip credit when skipping from playback of one media content item/track to playback of another media content item/track. The example being described here in relation to FIG. 11 differs from that example because here the value by which the credit is reduced depends upon at least one contextual characteristic.

In some implementations, the contextual characteristic(s) may be or include a temporal characteristic. For instance, the time at which the user provided the input to skip from playing the first media content item/track to playing the second media content item/track may affect the value by which the credit is reduced. If, for instance, the user provides user input to skip the remainder of the first media content item/track after a third of the track has been played he may lose 0.67 skip credit (since 67% of the media content item was skipped). Thus, the amount of skip credit that is lost may depend upon the amount of the media content item/track that was skipped.

Alternatively or additionally, the contextual characteristic(s) may be temporal in the sense that it/they may be related to the current usage level in the media content streaming service when the user input to skip is provided. For instance, if the usage level is low or the user is playing media content that is not particularly popular, the processor 12 may determine this and reduce the skip credit by a lesser value than when the usage level is high or the user is playing popular media content.

In some implementations, the contextual characteristic(s) may be or include a positional contextual characteristic. In such an example, the processor 12 has some means of ascertaining the position of the electronic device 100. This may be done, for example, using a connection to a wireless network (such as a cellular network) or using a satellite positioning receiver in the electronic device 100.

In these implementations, the position of the electronic device 100 when the user input to skip is identified by the processor 12 affects the value by which the credit is reduced. After the input is provided, the processor 12 determines the position of the electronic device 100 and reduces the credit in dependence upon the determination.

It may be, for example, that a promotion is offered by an entity whereby skip credit is not reduced for users positioned at a particular location. For instance, a concert could be sponsored such that all users at the concert are offered unlimited skips. Thus, when the processor 12 determines that the position of the electronic device is substantially the same as that of the concert, the processor 12 determines that the value by which the credit is to be reduced is zero.

In some implementations, the contextual characteristic(s) may be associated with the first media content (that is playing when the user input is provided to skip to the second media content). The value by which the credit is reduced may depend upon the first media content. For example, if the first media content is by a particular author/artist, the processor 12 may determine that the credit is to be reduced by a first value, but if the first media content is by a different author/artist, the processor 12 may determine that the credit is to be reduced by a second value, where the first and second values are different. For instance, a streaming service may deliberately cause a particular author's/artist's media content to be played more frequently than other authors/artists, but the value by which the skip credit is reduced is smaller than if media content by other artists/authors is skipped.

In some implementations, the at least one contextual characteristic associated with the skip input may relate to the number of users/electronic devices that are proximate to the electronic device at which the skip input is provided and at which the first media content is being played. For example, each of the electronic devices may be connected to one another by a wired or wireless link. The processor 12 of the electronic device at which the skip input is provided may identify that other electronic devices are located in the vicinity, and the value by which the skip credit is reduced may depend on the identification. For example, if a user's electronic device is interconnected with the electronic devices of two other proximate users, the processor 12 may treat the three user's collective skip credit as if it were “pooled”, such that when a user provides a skip input at a device playing the first media content, that user's/device's skip credit is reduced by a third of what it would otherwise have been reduced by (if the three devices had not been proximate to one another). The other user's skip credit might be reduced by the same amount.

In some implementations, the at least one contextual characteristic associated with the skip input may be or include a user's mental and/or physiological characteristics when the skip input is provided. Consider an example in which the user is jogging and listening to music. If the user jogs to the tempo of the music, the playback of higher tempo music may cause him to become fatigued more quickly than the playback of lower tempo music. If the processor 12 determines that the user is fatigued (or is becoming fatigued) when the skip input(s) is/are provided, it might reduce the skip credit by a lower value than if the user were not fatigued (or were not becoming fatigued). Effectively, an assumption is being made that the user is skipping to find lower tempo music and some degree of compensation is provided for this by reducing the skip credit by lower values. The processor 12 might, for example, determine that the user is fatigued (or is becoming fatigued) by receiving inputs from one or more heart rate sensors worn by the user and connected to the device 100 either in a wireless or wired manner.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

The blocks illustrated in the FIGS. 5 and 11 may represent steps in a method and/or sections of code in the computer program instructions 16. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

I/We claim:

1. Apparatus, comprising:
at least one processor; and
at least one memory storing computer program instructions configured, working with the at least one processor, to cause at least the following to be performed:
causing display of a graphical item pictorially identifying media content and having an appearance that depends upon prior playback of the media content.

2. The apparatus as claimed in claim 1, wherein the graphical item is an image.

3. The apparatus as claimed in claim 2, wherein the image is artwork pictorially identifying the media content.

4. The apparatus as claimed in claim 1, wherein the appearance of the graphical item identifies at least one more frequently played portion of the media content and at least one less frequently played portion of the media content.

5. The apparatus as claimed in claim 1, wherein highlighting in the graphical item graphically identifies the at least one more frequently played portion and the at least one less frequently played portion of the first media content.

6. The apparatus as claimed in claim 4, wherein the computer program instructions are configured, working with the at least one processor, to further cause the following to be performed: changing the appearance of the graphical item in dependence upon playback of the media content, such that a portion of the media content previously identified to be a less frequently played portion is identified to be a more frequently played portion.

7. The apparatus as claimed in claim 4, wherein the computer program instructions are configured, working with the at least one processor, to further cause the following to be performed: changing the appearance of the graphical item in dependence upon playback of the media content, such that a portion of the media content previously identified to be a more frequently played portion is identified to be a less frequently played portion.

8. The apparatus as claimed in claim 4, wherein the computer program instructions are configured, working with the at least one processor, to further cause the following to be performed: causing display of a further graphical item simultaneously with the graphical item, wherein the further graphical item pictorially identifies further media content and has an appearance that depends upon prior playback of the further media content.

9. The apparatus as claimed in claim 8, wherein the appearance of the further graphical item identifies at least one more frequently played portion and at least one less frequently played portion of the further media content.

10. The apparatus as claimed in claim 1, wherein the graphical item is displayed in a media content playback screen, and the appearance of the graphical item identifies one or more played portions of the media content and one or more unplayed portions of the media content.

11. The apparatus as claimed in claim 10, wherein playback of at least one of the unplayed portions was skipped by a user.

12. The apparatus as claimed in claim 1, wherein the media content comprises a plurality of media content items.

13. The apparatus as claimed in claim 8, wherein the plurality of media content items are audio tracks.

14. The apparatus as claimed in claim 1, wherein the media content is a single media content item.

15. The apparatus as claimed in claim 14, wherein the single media content item is a single audio track.

16. A method, comprising:
causing display of a graphical item pictorially identifying media content and having an appearance that depends upon prior playback of the media content.

17. The method as claimed in claim 16, wherein the appearance of the graphical item identifies at least one more frequently played portion of the media content and at least one less frequently played portion of the media content.

18. (canceled)

19. A non-transitory computer readable medium storing computer program instructions that, working with at least one processor, cause the method as claimed in claim 1.

20. Apparatus, comprising:
at least one processor; and
at least one memory storing computer program instructions configured, working with the at least one processor, to cause at least the following to be performed:
determining that one or more portions of media content was skipped during playback of the media content on a first occasion; and
adjusting playback of the media content on a second occasion, subsequent to the first occasion, based on the determination.

21. The apparatus as claimed in claim 20, wherein playback of the media content is adjusted on the second occasion by automatically skipping, on the second occasion, the one or more portions of the media content that were skipped on the first occasion.
